(19) United States
(12) Patent Application Publication
(10) Pub. No.: US 2026/0058782 A1
(43) Pub. Date: Feb. 26, 2026

(54) APPLYING OF TCI STATES IN TRANSMISSION AND RECEPTION

(71) Applicant: Nokia Technologies Oy, Espoo (FI)

(72) Inventors: Sami-Jukka HAKOLA, Oulu (FI); Timo KOSKELA, Oulu (FI); Keeth Saliya Jayasingle LADDU, Espoo (FI); Juha Pekka KARJALAINEN, Oulu (FI); Mihai ENESCU, Espoo (FI)

(21) Appl. No.: 19/105,537

(22) PCT Filed: Sep. 7, 2023
(86) PCT No.: PCT/EP2023/074530

§ 371 Date: Feb. 21, 2025

(30) Foreign Application Priority Data
Sep. 30, 2022 (GB) 2214415.8

(51) Int. Cl. H04L 5/00; H04W 72/232

(52) U.S. Cl. CPC H04L 5/0091; H04L 5/0051; H04W 72/232

(57) ABSTRACT

Embodiments of the present disclosure relate to methods, apparatuses and computer readable storage media for applying of transmission configuration indicator (TCI) states in transmission and reception. An apparatus receives an indication related to at least one TCI state of a plurality of TCI states including a first TCI state and a second TCI state. The apparatus determines whether at least one control resource set (CORESET) is associated with a single frequency network (SFN) mode and/or a repetition mode. Then, the apparatus monitors the at least one CORESET based on the first and/or second TCI state according to the association of the at least one CORESET with the SFN and/or repetition mode.

### FIELDS

Various example embodiments of the present disclosure generally relate to the field of telecommunication and in particular, to methods, apparatuses and computer readable storage medium for applying of transmission configuration indicator (TCI) states in transmission and reception.

### BACKGROUND

In unified TCI State in Release 17 (Rel-17), a single TCI state can be indicated to user equipment (UE). This indicated TCI state may be used for transmission and reception assumptions for a Physical Downlink Control Channel (PDCCH) and Physical Downlink Shared Channel (PDSCH), and/or a Physical Uplink Control Channel (PUCCH) and a Physical Uplink Shared Channel (PUSCH).

In an example scenario of single downlink control information (S-DCI) based multiple transmission reception point (TRP) operation, a single PDCCH can be used to schedule joint transmissions over two PDCSHs using two TCI states. The TCI states may be configured separately for the PDCCH and PDSCH. The unified TCI state in Rel 17 may be used as a baseline for enhancements of S-DCI based multiple-TRP (M-TRP) transmission.

### SUMMARY

In a first aspect of the present disclosure, there is provided an apparatus. The apparatus comprises at least one processor; and at least one memory storing instructions that, when executed by the at least one processor, cause the apparatus at least to perform: receiving an indication related to at least one transmission configuration indicator (TCI) state of a plurality of TCI states including a first TCI state and a second TCI state; determining whether at least one control resource set (CORESET) is associated with at least one of a single frequency network (SFN) mode or a repetition mode; and monitoring the at least one CORESET based on the first TCI state if the at least one CORESET is not associated with the at least one of the SFN mode or the repetition mode, or monitoring the at least one CORESET based on at least the second TCI state if the at least one CORESET is associated with the at least one of the SFN mode or the repetition mode.

In a second aspect of the present disclosure, there is provided an apparatus. The apparatus comprises at least one processor; and at least one memory storing instructions that, when executed by the at least one processor, cause the apparatus at least to perform: transmitting an indication related to at least one transmission configuration indicator (TCI) state of a plurality of TCI states including a first TCI state and a second TCI state; determining whether at least one control resource set (CORESET) is associated with at least one of a single frequency network (SFN) mode or a repetition mode; and performing transmission on a control channel using the at least one CORESET based on the first TCI state if the at least one coreset is unassociated with the at least one of the SFN mode or the repetition mode, or performing the transmission using the at least one CORESET based on at least the second TCI state if the at least one CORESET is associated with the at least one of the SFN mode or the repetition mode.

In a third aspect of the present disclosure, there is provided a method. The method comprises: receiving an indication related to at least one transmission configuration indicator (TCI) state of a plurality of TCI states including a first TCI state and a second TCI state; determining whether at least one control resource set (CORESET) is associated with at least one of a single frequency network (SFN) mode or a repetition mode; and monitoring the at least one CORESET based on the first TCI state if the at least one coreset is not associated with the at least one of the SFN mode or the repetition mode, or monitoring the at least one CORESET based on at least the second TCI state if the at least one CORESET is associated with the at least one of the SFN mode or the repetition mode.

In a fourth aspect of the present disclosure, there is provided a method. The method comprises: transmitting an indication related to at least one transmission configuration indicator (TCI) state of a plurality of TCI states including a first TCI state and a second TCI state; determining whether at least one control resource set (CORESET) is associated with at least one of a single frequency network (SFN) mode or a repetition mode; and performing transmission on a control channel using the at least one CORESET based on the first TCI state if the at least one coreset is unassociated with the at least one of the SFN mode or the repetition mode, or performing the transmission using the at least one CORESET based on at least the second TCI state if the at least one CORESET is associated with the at least one of the SFN mode or the repetition mode.

In a fifth aspect of the present disclosure, there is provided an apparatus. The first apparatus comprises means for receiving an indication related to at least one transmission configuration indicator (TCI) state of a plurality of TCI states including a first TCI state and a second TCI state; means for determining whether at least one control resource set (CORESET) is associated with at least one of a single frequency network (SFN) mode or a repetition mode; and means for monitoring the at least one CORESET based on the first TCI state if the at least one CORESET is not associated with the at least one of the SFN mode or the repetition mode, or means for monitoring the at least one CORESET based on at least the second TCI state if the at least one CORESET is associated with the at least one of the SFN mode or the repetition mode.

In a sixth aspect of the present disclosure, there is provided an apparatus. The second apparatus comprises means for transmitting an indication related to at least one transmission configuration indicator (TCI) state of a plurality of TCI states including a first TCI state and a second TCI state; means for determining whether at least one control resource set (CORESET) is associated with at least one of a single frequency network (SFN) mode or a repetition mode; and means for performing transmission on a control channel using the at least one CORESET based on the first TCI state if the at least one coreset is unassociated with the at least one of the SFN mode or the repetition mode, or means for performing the transmission using the at least one CORESET based on at least the second TCI state if the at least one CORESET is associated with the at least one of the SFN mode or the repetition mode.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling diagram of a communication process according to some example embodiments of the present disclosure;

FIG. 3 illustrates a flowchart of a method according to some example embodiments of the present disclosure;

FIG. 4 illustrates an example diagram of example mapping of control resource sets (CORESETs) and search space sets in the repetition mode according to some example embodiments of the present disclosure;

FIG. 5 illustrates a flowchart of a method according to some example embodiments of the present disclosure;

FIG. 6 illustrates an example signaling diagram of applying TCI states according to some example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprise”, “comprising”, “have”, “having”, “include” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a transmission reception point (TRP), for example, a base station (BS) or an access point (AP), a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a mobile device, a user device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In a unified TCI indication framework in Rel 17, a beam indication or rather a TCI state indication (for example, an indication which TCI state is used for transmission and/or reception assumptions for signals and channels associated with the TCI State) may be transmitted to the UE. For example, for a serving cell, the unified TCI State type is configured to be either joint or sperate in uplink (UL) and downlink (DL). For the joint TCI state type, the indicated TCI state is used for both UL and DL. For the separate TCI state type, the DL and UL TCI state types are indicated separately (with separate indications).

If the TCI state type is joint (or, combined), the UE may be configured with a list of TCI states using Radio Resource Control (RRC) signaling. If the TCI state type is separate, the UE may be configured with a DL TCI State list and a UL TCI State list. The configuration may be done using RRC signaling while a number of TCI states may be selected via a Media Access Control (MAC) Control Element (CE) (MAC CE or MAC-CE) which may become activated based on DCI.

To indicate a TCI state (joint in UL and DL) or TCI States (separate in UL and DL), the network may determine a DCI codepoint (which is a value in a DCI message) that corresponds to a DCI codepoint in the MAC CE that activated the TCI state(s). Upon receiving the DCI based beam indication (via a DCI codepoint), the UE may apply the indicated TCI States for the indicated channels (the PDSCH, PDCCH, PUSCH, and/or PUCCH). Alternatively, if only a single codepoint (comprising one or more TCI States) is activated by the MAC CE, it corresponds to the indicated codepoint (and DCI may not/is not required to be used). Thus, the indication of TCI states can be based on MAC CE, or MAC CE and DCI.

The unified TCI state in Rel-17 may be used as a baseline for enhancements of S-DCI and Multi-DCI (M-DCI) based M-TRP (or MTRP) transmission for uplink (UL) multi-panel transmission in Release 18 (Rel-18). In an example scenario of S-DCI based multiple TRP operation, a single PDCCH can be used to schedule joint transmission over two PDCSHs using two TCI states. The TCI states may be configured separately for the PDCCH and PDSCH. However, the unified TCI framework in Rel-17 does not support multiple TRP operation, and Single Frequency Network (SFN) operation is not supported in Rel-17 for PDCCH S-DCI operation. There is a need to extend the unified TCI state framework (for example, as defined in Rel-17) for S-DCI based MTRP and to support PDCCH SFN where the PDCCH transmission (with same PDCCH information) is performed simultaneously by using one or more TRPs or one or more indicated TCI states, but the transmission is seen as one single PDCCH transmission.

Moreover, PDCCH repetition is allowed in Rel-17. The PDCCH repetition is based on linking of search space (SS) sets. If the linking is provided, the UE assumes the linked search space sets to provide same downlink control information. There is also a need to extend the unified TCI state framework to support PDCCH Repetition in S-DCI based MTRP. For example, the network may configure the linking between two search space sets (that are further associated with control resource sets (CORESETs)) that are monitored using the configured TCI states.

For the unified TCI framework extension for S-DCI based MTRP, to inform the association with the joint or DL TCI state(s) indicated by DCI or MAC CE for PDCCH repetition and/or PDCCH SFN, there may be some alternative schemes. For example, RRC parameter(s) in a CORESET configuration may be used to inform the UE whether and/or which indicated joint, or DL TCI state(s) shall be applied to the corresponding PDCCH receptions on the CORESET. As another example, an RRC parameter in a CORESET configuration may be used to inform that the CORESET belongs to which CORESET group(s), and the indicated joint or DL TCI state(s) is associated with each CORESET group. Alternatively, MAC-CE may be used to inform the UE whether and/or which indicated joint or/DL TCI state(s) shall be applied to the corresponding PDCCH receptions on a CORESET. In some scenarios, there may be a switch between multi-TRP and single TRP operation.

Example embodiments of the present disclosure propose an enhanced scheme for S-DCI based multi-TRP operation in a unified TCI state framework. With the scheme, at least one TCI state of a plurality of TCI states is dynamically indicated to an apparatus which may be a terminal device or a UE. Based on association of a CORESET and a SFN mode and/or a repetition mode, the apparatus determines which one of the TCI states is to be used for monitoring the CORESET. If the CORESET is not associated with the SFN and/or repetition mode, a first TCI state of the TCI states can be used. If the CORESET is associated with the SFN and/or repetition mode, at least a second TCI state of the TCI states can be used.

In this way, if two unified TCI states (including the first and second TCI states) are indicated or activated to a UE, it may be determined, based on the configuration of SFN and/or repetition, how to apply the first and second indicated unified TCI states. Thus, S-DCI based multi-TRP operation can be performed in the unified TCI state framework.

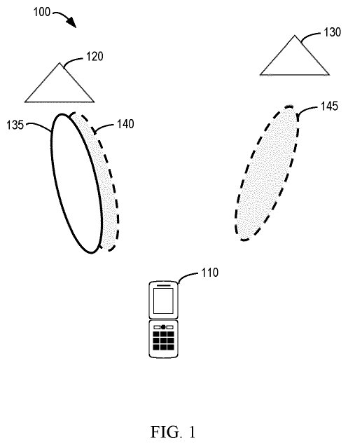

FIG. 1 illustrates an example communication environment 100 in which example embodiments of the present disclosure can be implemented. In the communication environment 100, a plurality of communication devices, including a first apparatus 110, a second apparatus 120 and a third apparatus 130, can communicate with each other. In this example, the first apparatus 110, which may be a terminal device, may simultaneously communicate with the apparatuses 120 and 130, which may be network devices such as TRPs.

It is to be understood that the number of devices and their connections shown in FIG. 1 are only for the purpose of illustration without suggesting any limitation. The communication environment 100 may include any suitable number of devices configured to implementing example embodiments of the present disclosure.

In the following, for the purpose of illustration, some example embodiments are described with the first apparatus 110 operating as a terminal device and the apparatuses 120 and 130 operating as network devices (for example, TRPs). However, in some example embodiments, operations described with respect to a terminal device may be implemented at a network device or other devices, and operations described with respect to a network device may be implemented at a terminal device or other devices.

In some example embodiments, if the first apparatus 110 is a terminal device and the apparatuses 120 and 130 are network devices, a link from the second apparatus 120 or the third apparatus 130 to the first apparatus 110 is referred to as a downlink (DL), while a link from the first apparatus 110 to the second apparatus 120 or the third apparatus 130 is referred to as an uplink (UL). If the apparatuses 110, 120 and 130 are all terminal devices, a link between these apparatuses is referred to as a sidelink (SL).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Some example embodiments may be implemented in an example scenario of S-DCI based multiple TRP operation. For example, the first apparatus 110 (for example, a UE) may receive transmissions from the two apparatuses 120 and 130 (for example, TRPs) via a plurality of channels, for example, via a PDCCH 135 and two PDSCHs 140 and 145. The single PDCCH 135 from the second apparatus 120 may schedule joint transmission over two PDCSHs 140 and 145.

In addition, PDCCH SFN may be enabled. The PDCCH transmissions from the two apparatuses 120 and 130 to the first apparatus 110 with same PDCCH information may be performed simultaneously by using one or more (indicated) TRP states, and the transmissions may be seen by the first apparatus 110 as one single PDCCH transmission. PDCCH repetition may also be allowed. The linking between two or more search space sets, associated with CORESETs, may be configured by the network, which may be monitored using the configured TCI states. PDCCH repetition may be based on the linking of search space set. If a linking is provided, a UE may assume the search space sets to provide same downlink control information.

In some example embodiments, if one or more unified TCI states (for example, either or both of a first TCI state and a second TCI state) are indicated to the first apparatus 110, the first apparatus 110 may determine how to apply the first and/or second indicated unified TCI state based on the configuration of SFN and/or PDCCH repetition.

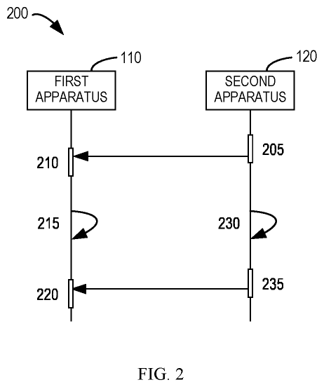

FIG. 2 shows an example signaling diagram of a communication process 200 between the first and second apparatuses 110 and 120 according to some example embodiments of the present disclosure.

In the process 200, the second apparatus 120 (for example, a TRP) transmits (205) to the first apparatus 110 (for example, a UE), an indication related to at least one TCI state of a plurality of TCI states. These TCI states may include a first TCI state and a second TCI state. Upon receiving (210) the indication, the first apparatus 110 may determine how to use the indicated TCI state based on association between at least one CORESET to be monitored and at least one of a SFN mode or a repetition mode.

As shown in FIG. 2, the first apparatus 110 determines (215) whether at least one CORESET is associated with at least one of a SFN mode or a repetition mode. Based on the determining result, the first apparatus 110 monitors (220) the at least one CORESET based on either the first or second TCI state. For example, if the CORESET is unassociated with the SFN and/or repetition mode, the first TCI state may be applied (or alternatively the second TCI state e.g., one of the TCI states). If associated, the second TCI state may be applied as well.

Similar rules are employed at the second apparatus 120. The second apparatus 120 determine (230) whether at least one CORESET is associated with at least one of the SFN mode or a repetition mode. Then, the second apparatus 120 performs transmission on a control channel (for example, a PDCCH) using the at least one CORESET based on the association of the CORESET with the SFN and/or repetition mode. The first and/or second TCI state may be used for the transmission. The control channel may be used to schedule further (data) transmission from the second apparatus 120 and/or transmission from other apparatuses which may include the third apparatus 130. In this way, the unified TCI state framework may be extended for S-DCI M-TRP operation and to support PDCCH (and/or PDSCH) SFN and PDCCH repetition.

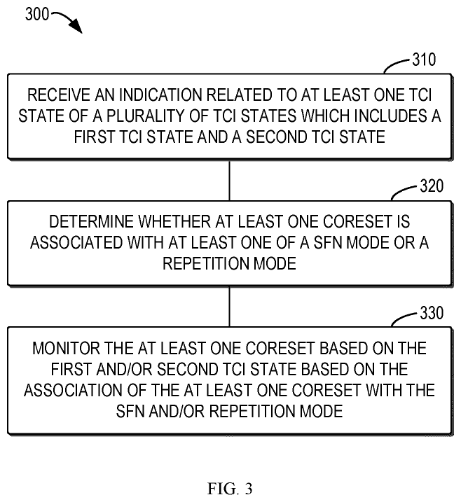

FIG. 3 shows a flowchart of an example method 300 implemented at the first apparatus 110 in accordance with some example embodiments of the present disclosure.

At block 310, the first apparatus 110 (e.g., the UE) receives an indication related to at least one TCI state of a plurality of TCI states which includes a first TCI state and a second TCI state. The first and second TCI states may be the unified TCI states in the unified TCI state framework. For example, the first apparatus 110 may receive an indication of the first and second unified TCI states for one or more CORESETs.

In some example embodiments, the TCI state may be indicated using a DCI based indication. The TCI state may be selected from a set of TCI states which are activated using a MAC CE out of an RRC configured set. As an alternative, a MAC CE based indication may be used where the MAC CE indicates only one active TCI state out of the RRC configured set, then no DCI may be needed.

Any suitable number of TCI states may be indicated. For example, in the unified TCI framework, a UE (e.g., the first apparatus 110) may have either one, or up to N (N=2 is currently considered in R18) indicated TCI states. More than 2 indicated TCI states may be also possible.

In some example embodiments, the first apparatus 110 may be provided with the plurality of TCI states via higher layer parameters such as information regarding the TCI states. For example, it's assumed that the first apparatus 110 is provided with two indicated TCI states. The indicated TCI states may have indices 0 and 1 (or first and second, respectively).

At block 320, the first apparatus 110 determines whether at least one CORESET is associated with at least one of a SFN mode or a repetition mode. At block 330, the first apparatus 110 monitors the at least one CORESET based on the first and/or second TCI states based on the association of the at least one CORESET with the SFN and/or repetition mode.

If the CORESET is not associated with the SFN and/or repetition mode, the monitoring is performed based on the first TCI state. If the CORESET is associated with the SFN and/or repetition mode, at least the second TCI state may be used. In some example embodiments, if such association exists, the first apparatus 110 may monitor the at least one CORESET based on the first and second TCI states. Alternatively, if the CORESET is not associated with the SFN and/or repetition mode, the monitoring is performed based on the second TCI state.

By way of example, if the CORESET is not associated with SFN and/or repetition, and the indicated TCI State is the first unified TCI state (or the second unified TCI state), then the first apparatus 110 may apply the indicated TCI state for the CORESET. For example, one of the first unified TCI state or the second unified TCI state may be indicated but both the first and the second unified TCI states are not indicated at the same time. Alternatively, or in addition, if the indicated TCI State is the second TCI State, this indicated TCI state may have no effect because it is not applied.

Taking a UE as an example of the first apparatus 110, in the reception according to the TCI state(s), the first apparatus 110, which may be a UE, may use a DL RS indicated by the indicated TCI state, as a reference or as a Quasi co-location (QCL) assumption for receiving a PDCCH demodulation reference signal (DMRS). This means that UE assumes the reception of the PDCCH according to the indicated TCI state. Alternatively, if there are two RSs indicated by the TCI state, the UE may apply the one with type D QCL which is the one providing the spatial RX reference.

In the multiple TRP communication, the first apparatus 110, which may be a UE, may be configured with multiple indicated TCI states, each providing the QCL reference for PDCCH reception. Multiple panels may be used by the UE (for example, in higher frequencies) to receive transmission on multiple TCI states simultaneously or separately. It may not be explicitly visible to the network that which panels the UE use to receive or how many panels it has for reception.

In some example embodiments, the first apparatus 110 may have one or more CORESETs configured, and the logic is used per CORESET. For example, if a CORESET for which the indicated TCI state applies is not associated either with SFN or with repetition (for example, via SS set linking), then the CORESET may always be monitored with the specific indicated TCI state, for example, with the index “0” (first). Alternatively, the CORESET may always be monitored with the specific indicated TCI state, for example, with the index “1” (second, e.g., when only one TCI state is indicated).

In some example embodiments, the association of a CORESET with the SFN mode may be based on the SFN configuration for the CORESET. If a CORESET is configured with the SFN mode, it may be determined that the CORESET is associated with the SFN mode. Otherwise, if the CORESET is configured without the SFN mode, it may be determined that the CORESET is unassociated with the SFN mode. In one embodiment, if the CORESET is associated with the SFN mode, then the CORESET applies both the indicated TCI states (“0” and “1”), if indicated.

For example, the SFN mode configuration may be a configured parameter (for example, SFNparameter) for a CORESET, for example, with a specific CORESET identification (ID). For any CORESET configured with SFNparameter, after the indication of the first and second indicated TCI states is received, the first and second TCI states may be applied. For any CORESET which is not configured with the SFNparameter, the first indicated TCI state may be applied. The SENparameter, may be configured using RRC or changed using MAC CE/DCI (SFN used/not used).

By applying the first and second TCI states for the specific CORESET configured with SFNparameters, the first apparatus 110 may be configured to monitor the search space(s) of the CORESET using two different QCL assumptions for reception. For example, the first TCI state may provide a first (DL) RS with first QCL typeD assumption, and the second one may provide a second (DL) RS with second QCL typeD assumption. In such a situation, the first apparatus 110, which may be a UE, may receive the PDCCH transmission using two different assumptions for QCL reference. For example, the UE may use 2 different panels or beams to receive the PDCCH transmission on the CORESET resources.

In some example embodiments, the association of a CORESET with the SFN mode may be determined based on the number of TCI states applied or indicated for the CORESET. In one example, if a TCI State is indicated, it may mean that it is indicated for all the CORESETs or CORESETs that are grouped to the same group. For example, in addition to a configuration (referred to as a first configuration) of the SFN mode for a CORESET, for example, via a higher layer parameter, the first apparatus 110 may receive a second configuration for the CORESET in terms of how to follow the indicated TCI state(s). For example, for a CORESET, it may be configured to follow an indication related to the first and second TCI states, or an indication related to one of the first and second TCI states. If the indication related to the first and second TCI states is configured to be followed, which means that two TCI states can be indicated or applied to the CORESET, then it may be determined that the CORESET is associated with the SFN mode. If the indication related to one of the first and second TCI states is configured to be followed, which means that only one TCI state can be indicated or applied to the CORESET, it may be determined that the CORESET is not associated with the SFN mode.

Taking a UE as an example of the first apparatus 110, a SFN mode configuration, which may be (for example, the first configuration) configured by a higher layer parameter (for example, sfnSchemePdcch within the serving cell configuration). Whether to follow indicated TCI state(s) (or not) may be the second configuration which may be configured per CORESET (for example, for each CORESET ID). For any CORESET configured to follow the indication of the first and second indicated TCI states, UE PDCCH reception associated to that CORESET may be considered as SFN operation with the first and second TCI states. The UE may assume the same information transmitted simultaneously on the CORESET resources by using the first TCI state and the second TCI state. Since the transmitted information is the same, this may be seen by UE as a single transmission although (or where) two different beams and/or links (or TRPs) are used to transmit.

For any CORESET configured or defined to follow the indication of only one of first and second indicated TCI states, UE PDCCH reception associated to that CORESET may be considered as non-SFN operation, regardless of the SFN mode configuration applied for the serving cell. In this way, the determination whether a CORESET is SFN related or not may depend on the number of TCI state applied or indicated for the CORESET.

In one example, a CORESET may be configured or defined to follow the indication of only one of first and second indicated TCI states (or both). In one example, if a CORESET can be configured to follow (first and second TCI states) but is not associated with any parameters indicating the use of both TCI States for reception (e.g., SFN mode/repetition), it may apply only one of the indicated TCI states (e.g., the first or the second TCI state).

In some example embodiments, if the at least one CORESET is associated with the repetition mode, the first apparatus 110 may monitor, based on the first TCI state, a CORESET of the at least one CORESET associated with a lower identification (ID) and/or an earlier monitoring occasion. The second TCI state may be applied for CORESET associated with a higher ID and/or a later monitoring occasion. As a further example, the previous example may be determined/configured to be vice versa (e.g., lower CORESET ID or earlier monitoring occasion is associated with second TCI state). The ID may comprise a SS Set ID (or SS Set) of linked SS Sets or a CORESET ID of the CORESETs associated via SS Set linking. For example, if more CORESETs are configured with the repetition mode, then for a CORESET associated with a lower SS Set (or SS Set) ID among the linked SS Sets, or for a CORESET with a lower ID among the CORESETs associated via SS Set linking, the first indicated TCI state (0) may be applied. The second indicated TCI state (1) may be applied for a CORESET associated with a higher ID, or vice versa.

As another example, if a CORESET is associated with linked SS set that has the earlier monitoring occasion in time, the CORESET may apply the first indicated TCI state (0). The CORESET later in time may apply the second indicated TCI state (1). This time refers to the search space monitoring occasion, and the monitoring occasions for the CORESET (for example, for PDCCH candidates) may be informed by the search space. The earlier time means that, out of the 2 linked search space (sets), the CORESET that is associated with a search space set with the earlier monitoring occasion is monitored on the first indicated TCI state. The CORESET with the later monitoring occasion is monitored using second TCI state (2).

In some example embodiments, if a CORESET is configured as SFN CORESET, and the CORESET is indicated with one (or is not indicated with two TCI States (e.g., first and/or second TCI State)) for the CORESET, the UE may determine not to apply the indicated TCI state for the CORESET. In one example, the UE may not be required to monitor the CORESET for control information according to the search space configuration.

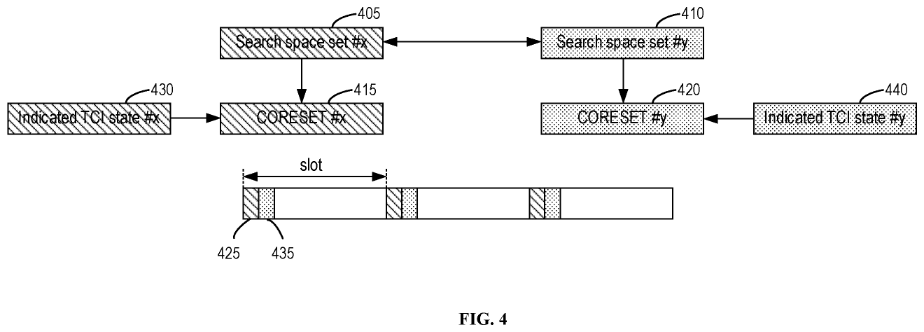

FIG. 4 shows example mapping of CORESETs and search space sets in the repetition mode according to some example embodiments of the present disclosure.

As shown in FIG. 4, a search space set 405 (labeled as search space set #x) and a search space set 410 (labeled as search space set #y) are linked via SS Set linking. A CORESET 415 (labeled as CORESET #x) is associated with the search space set 405, and a CORESET 420 (labeled as CORESET #y) is associated with the search space set 410. The CORESETs 415 and 420 are in the repetition mode.

In this example, the CORESET 415, which is associated with linked search space set #x 405 that has an earlier monitoring occasion 425 in time, applies the first indicated TCI state 430 (labeled as indicated TCI state #x). The CORESET #y 420, which is associated with linked search space set 410 that has a later monitoring occasion 435 in time, applies the second indicated TCI state 440 (labeled as indicated TCI state #y).

Still with reference to FIG. 3, in some example embodiments, one CORESET may be configured with the repetition mode. For example, a CORESET may be configured to be associated with both linked SS sets. In this case, the CORESET may be assumed to be configured with the repetition mode. Then, it may be determined that the CORESET is associated with the repetition mode.

For the CORESET configured with the repetition mode, the first indicated TCI state (0) may be applied for a first SS set of the CORESET that has the monitoring occasions earlier in time. Accordingly, the first SS set may be monitored based on the first TCI state. The second TCI state may be applied for monitoring of a second SS set of the CORESET that has the monitoring occasion later in time. That is, the second SS set may be monitored based on the second TCI state.

In some example embodiments, the at least CORESET may configured without an index of a resource pool, and/or with a single index of a resource pool. In this way, the aforementioned rules may be used if a UE is not configured with a CORESETPoolIndex value for any of the CORESETs, or if CORESETs of the DL bandwidth part (BWP) are configured with a single CORESETpoolindex value.

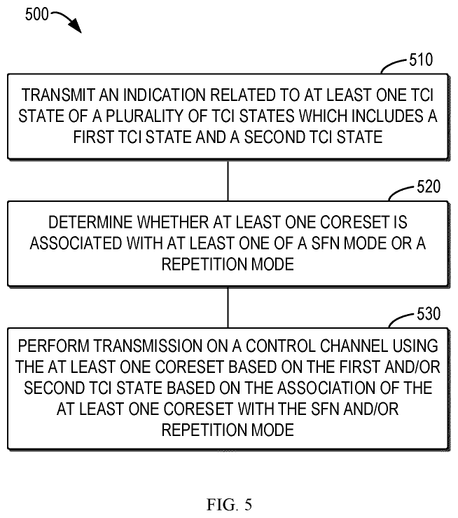

FIG. 5 shows a flowchart of an example method 500 implemented at the second apparatus 120 or the third apparatus 130 in accordance with some example embodiments of the present disclosure. For the purpose of discussion, the method 500 will be described from the perspective of the second apparatus 120 in FIG. 1.

At block 510, the second apparatus 120 transmits an indication related to at least one TCI state of a plurality of TCI states including a first TCI state and a second TCI state. At block 520, the second apparatus 120 determines whether at least one CORESET is associated with at least one of a SFN mode or a repetition mode.

Based on the association of the at least one CORESET and the at least one of the SFN mode or the repetition mode, at block 530, the second apparatus 120 performs transmission on a control channel using the at least one CORESET based on the first and/or second TCI state. If the at least one coreset is unassociated with the at least one of the SFN mode or the repetition mode, the first TCI state is used. If the at least one CORESET is associated with the at least one of the SFN mode or the repetition mode, at least the second TCI state is used.

In some example embodiments, if the at least one CORESET is associated with the at least one of the SFN mode or the repetition mode, the second apparatus 120 may perform the transmission using the at least one CORESET based on the first and second TCI states.

In some example embodiments, the second apparatus 120 may perform, based on the first TCI state, the transmission using a CORESET of the at least one CORESET associated with a lower identification and/or an earlier transmission occasion if the at least one CORESET is associated with the repetition mode.

In some example embodiments, the second apparatus 120 may determine that a CORESET of the at least one CORESET is associated with the repetition mode if the CORESET is configured with the repetition mode. Then, the second apparatus 120 may perform, based on the first TCI state, the transmission using a first SS set of the CORESET associated with an earlier transmission of the CORESET. And then, the second apparatus 120 may perform, based on the second TCI state, the transmission using a second SS set of the CORESET associated with a later transmission occasion of the CORESET.

In some example embodiments, the second apparatus 120 may determine that a CORESET of the at least one CORESET is associated with the SFN mode if the CORESET is configured with the SFN mode, and/or determine that the CORESET is unassociated with the SFN mode if the CORESET is configured without the SFN mode.

In some example embodiments, the second apparatus 120 may determine that a CORESET of the at least one CORESET configured with the SFN mode is associated with the SFN mode if an indication related to the first and second TCI states is configured to be followed for the CORESET, and/or determine that the CORESET is unassociated with the SFN mode if an indication related to one of the first and second TCI states is configured to be followed for the CORESET.

In some example embodiments, the second apparatus 120 may transmit a first configuration of the SFN mode for the CORESET and transmit a second configuration of following the indication related to the first and second TCI states or the indication related to the one of the first and second TCI states for the CORESET.

In some example embodiments, the at least CORESET may be configured without an index of a resource pool, and/or with a single index of a resource pool.

In some example embodiments, the indication related to the at least one TCI state may be transmitted via DCI.

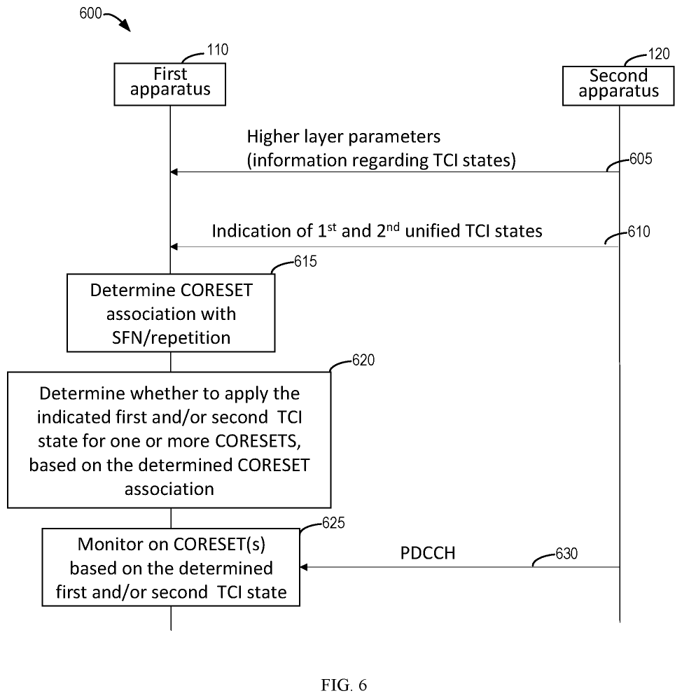

FIG. 6 shows an example signaling diagram 600 of applying TCI states according to some example embodiments of the present disclosure. For the purpose of discussion, the failure case will be described with respect to FIG. 1. It should be understood that this is just discussed for illustration, without suggesting any limitation to the present disclosure.

As shown in FIG. 6, the first apparatus 110, which may be a UE, may receive (605) higher layer parameters including information regarding TCI states from the second apparatus 120 which may be a network node. The first apparatus 110 may receive (610) an indication of the first and second unified TCI states from the second apparatus 120. The first apparatus 110 may determine (615) CORESET association with SFN/repetition. Then, the first apparatus 110 may determine (620) whether to apply the indicated first and/or second TCI state for one or more CORESETs, based on the determined CORESET association. Then, the first apparatus 110 may monitor (625) on CORESET(s) using the determined first and/or second TCI state for a PDCCH from the second apparatus 120.

In this way, the unified TCI state framework may be extended for the S-DCI multi-TRP operation, and it may be determined, based on the configuration of SFN and/or PDCCH repetition, how to apply the first and second indicated unified TCI states.

In some example embodiments, an apparatus capable of performing any of the method 300 (for example, the first apparatus 110 in FIG. 1) may comprise means for performing the respective operations of the method 300. The means may be implemented in any suitable form. For example, the means may be implemented in a circuitry or software module. The first apparatus may be implemented as or included in the first apparatus 110 in FIG. 1.

In some example embodiments, the apparatus comprises means for receiving an indication related to at least one transmission configuration indicator (TCI) state of a plurality of TCI states including a first TCI state and a second TCI state; means for determining whether at least one control resource set (CORESET) is associated with at least one of a single frequency network (SFN) mode or a repetition mode; and means for monitoring the at least one CORESET based on the first TCI state if the at least one coreset is not associated with the at least one of the SFN mode or the repetition mode, or means for monitoring the at least one CORESET based on at least the second TCI state if the at least one CORESET is associated with the at least one of the SFN mode or the repetition mode.

In some example embodiments, if the at least one CORESET is associated with the at least one of the SFN mode or the repetition mode, the apparatus is caused to monitor the at least one CORESET based on the first and second TCI states.

In some example embodiments, the means for monitoring the at least one CORESET based on the first and second TCI states comprises: means for monitoring, based on the first TCI state, a CORESET of the at least one CORESET associated with a lower identification and/or an earlier monitoring occasion if the at least one CORESET is associated with the repetition mode.

In some example embodiments, the means for determining whether the at least one CORESET is associated with the at least one of the SFN mode or the repetition mode comprises: means for determining that a CORESET of the at least one CORESET is associated with the repetition mode if the CORESET is configured with the repetition mode; and means for monitoring the at least one CORESET based on the first and second TCI states comprises: means for monitoring, based on the first TCI state, a first search space (SS) set of the CORESET associated with an earlier monitoring occasion of the CORESET; and means for monitoring, based on the second TCI state, a second SS set of the CORESET associated with a later monitoring occasion of the CORESET.

In some example embodiments, the means for determining whether the at least one CORESET is associated with the at least one of the SFN mode or the repetition mode comprises: means for determining that a CORESET of the at least one CORESET is associated with the SFN mode if the CORESET is configured with the SFN mode, and/or means for determining that the CORESET is unassociated with the SFN mode if the CORESET is configured without the SFN mode.

In some example embodiments, the means for determining whether the at least one CORESET is associated with the at least one of the SFN mode or the repetition mode comprises: means for receiving a first configuration of the SFN mode for a CORESET of the at least one CORESET; means for receiving a second configuration of following an indication related to the first and second TCI states or an indication related to one of the first and second TCI states for the CORESET; and means for determining that the CORESET is associated with the SFN mode if the indication related to the first and second TCI states is configured to be followed, or means for determining that the CORESET is unassociated with the SFN mode if the indication related to the one of the first and second TCI states is configured to be followed.

In some example embodiments, the at least CORESET is configured without an index of a resource pool, and/or with a single index of a resource pool.

In some example embodiments, the indication related to the at least one TCI state is received via downlink control information (DCI).

In some example embodiments, an apparatus capable of performing any of the method 500 (for example, the second apparatus 120 or the third apparatus 130 in FIG. 1) may comprise means for performing the respective operations of the method 500. The means may be implemented in any suitable form. For example, the means may be implemented in a circuitry or software module. The second apparatus may be implemented as or included in the second apparatus 120 or the third apparatus 130 in FIG. 1.

In some example embodiments, the apparatus comprises means for transmitting an indication related to at least one transmission configuration indicator (TCI) state of a plurality of TCI states including a first TCI state and a second TCI state; means for determining whether at least one control resource set (CORESET) is associated with at least one of a single frequency network (SFN) mode or a repetition mode; and means for performing transmission on a control channel using the at least one CORESET based on the first TCI state if the at least one coreset is unassociated with the at least one of the SFN mode or the repetition mode, or means for performing the transmission using the at least one CORESET based on at least the second TCI state if the at least one CORESET is associated with the at least one of the SFN mode or the repetition mode.

In some example embodiments, if the at least one CORESET is associated with the at least one of the SFN mode or the repetition mode, the apparatus is caused to perform the transmission using the at least one CORESET based on the first and second TCI states.

In some example embodiments, the means for performing the transmission using the at least one CORESET based on the first and second TCI states comprises: means for performing, based on the first TCI state, the transmission using a CORESET of the at least one CORESET associated with a lower identification and/or an earlier transmission occasion if the at least one CORESET is associated with the repetition mode.

In some example embodiments, the means for determining whether the at least one CORESET is associated with the at least one of the SFN mode or the repetition mode comprises: means for determining that a CORESET of the at least one CORESET is associated with the repetition mode if the CORESET is configured with the repetition mode; and means for performing the transmission using the at least one CORESET based on the first and second TCI states comprises: means for performing, based on the first TCI state, the transmission using a first search space (SS) set of the CORESET associated with an earlier transmission of the CORESET; and means for performing, based on the second TCI state, the transmission using a second SS set of the CORESET associated with a later transmission occasion of the CORESET.

In some example embodiments, the means for determining whether the at least one CORESET is associated with the at least one of the SFN mode or the repetition mode comprises: means for determining that a CORESET of the at least one CORESET is associated with the SFN mode if the CORESET is configured with the SFN mode, and/or means for determining that the CORESET is unassociated with the SFN mode if the CORESET is configured without the SFN mode.

In some example embodiments, the means for determining whether the at least one CORESET is associated with the at least one of the SFN mode or the repetition mode comprises: means for determining that a CORESET of the at least one CORESET configured with the SFN mode is associated with the SFN mode if an indication related to the first and second TCI states is configured to be followed for the CORESET, and/or means for determining that the CORESET is unassociated with the SFN mode if an indication related to one of the first and second TCI states is configured to be followed for the CORESET.

In some example embodiments, the apparatus further comprises means for transmitting a first configuration of the SFN mode for the CORESET; and means for transmitting a second configuration of following the indication related to the first and second TCI states or the indication related to the one of the first and second TCI states for the CORESET.

In some example embodiments, the at least CORESET is configured without an index of a resource pool, and/or with a single index of a resource pool.

In some example embodiments, the indication related to the at least one TCI state is transmitted via downlink control information (DCI).

In some example embodiments, the indication related to the at least one TCI state is transmitted via MAC Control Element (MAC CE).

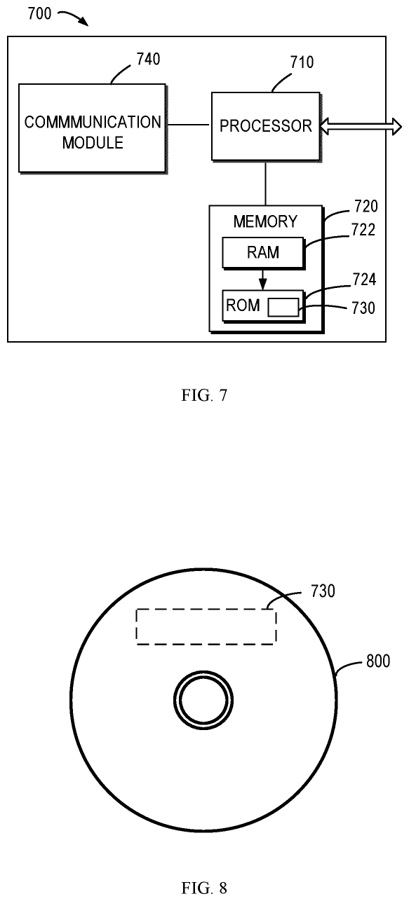

FIG. 7 is a simplified block diagram of an apparatus 700 that is suitable for implementing example embodiments of the present disclosure. The apparatus 700 may be provided to implement a communication device, for example, the first apparatus 110, the second apparatus 120, or the third apparatus 130 as shown in FIG. 1, 2, 3, 5, or 6. As shown, the apparatus 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The apparatus 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the apparatus 700 may perform any process of the disclosure as discussed with reference to FIG. 1 to FIG. 6. The example embodiments of the present disclosure may also be implemented by hardware or by a combination of software and hardware.

In some example embodiments, the program 730 may be tangibly contained in a computer readable medium which may be included in the apparatus 700 (such as in the memory 720) or other storage devices that are accessible by the apparatus 700. The apparatus 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. An apparatus comprising:
at least one processor; and
at least one memory storing instructions that, when executed by the at least one processor, cause the apparatus at least to perform:
receiving an indication related to at least one transmission configuration indicator (TCI) state of a plurality of TCI states including a first TCI state and a second TCI state;
determining whether at least one control resource set (CORESET) is associated with at least one of a single frequency network (SFN) mode or a repetition mode; and
monitoring the at least one CORESET based on the first TCI state if the at least one CORESET is unassociated with the at least one of the SFN mode or the repetition mode, or
monitoring the at least one CORESET based on at least the second TCI state if the at least one CORESET is associated with the at least one of the SFN mode or the repetition mode.

25. The apparatus of claim 24, wherein, if the at least one CORESET is associated with the at least one of the SFN mode or the repetition mode, the apparatus is caused to monitor the at least one CORESET based on the first and second TCI states.

26. The apparatus of claim 25, wherein monitoring the at least one CORESET based on the first and second TCI states comprises:
monitoring, based on the first TCI state, a CORESET of the at least one CORESET associated with a lower identification and/or an earlier monitoring occasion if the at least one CORESET is associated with the repetition mode.

27. The apparatus of claim 25, wherein
determining whether the at least one CORESET is associated with the at least one of the SFN mode or the repetition mode comprises:
determining that a CORESET of the at least one CORESET is associated with the repetition mode if the CORESET is configured with the repetition mode; and
monitoring the at least one CORESET based on the first and second TCI states comprises:
monitoring, based on the first TCI state, a first search space (SS) set of the CORESET associated with an earlier monitoring occasion of the CORESET; and
monitoring, based on the second TCI state, a second SS set of the CORESET associated with a later monitoring occasion of the CORESET.

28. The apparatus of claim 24, wherein determining whether the at least one CORESET is associated with the at least one of the SFN mode or the repetition mode comprises:
determining that a CORESET of the at least one CORESET is associated with the SFN mode if the CORESET is configured with the SFN mode, and/or
determining that the CORESET is unassociated with the SFN mode if the CORESET is configured without the SFN mode.

29. The apparatus of claim 24, wherein determining whether the at least one CORESET is associated with the at least one of the SFN mode or the repetition mode comprises:
receiving a first configuration of the SFN mode for a CORESET of the at least one CORESET;
receiving a second configuration of following an indication related to the first and second TCI states or an indication related to one of the first and second TCI states for the CORESET; and
determining that the CORESET is associated with the SFN mode if the indication related to the first and second TCI states is configured to be followed, or
determining that the CORESET is unassociated with the SFN mode if the indication related to the one of the first and second TCI states is configured to be followed.

30. The apparatus of claim 24, wherein the at least CORESET is configured without an index of a resource pool, and/or with a single index of a resource pool.

31. The apparatus of claim 24, wherein the indication related to the at least one TCI state is received via downlink control information (DCI).

32. A method comprising:
receiving an indication related to at least one transmission configuration indicator (TCI) state of a plurality of TCI states including a first TCI state and a second TCI state;
determining whether at least one control resource set (CORESET) is associated with at least one of a single frequency network (SFN) mode or a repetition mode; and
monitoring the at least one CORESET based on the first TCI state if the at least one coreset is not associated with the at least one of the SFN mode or the repetition mode, or
monitoring the at least one CORESET based on at least the second TCI state if the at least one CORESET is associated with the at least one of the SFN mode or the repetition mode.

33. The method of claim 32, wherein, if the at least one CORESET is associated with the at least one of the SFN mode or the repetition mode, the apparatus is caused to monitor the at least one CORESET based on the first and second TCI states.

34. The method of claim 33, wherein monitoring the at least one CORESET based on the first and second TCI states comprises:
monitoring, based on the first TCI state, a CORESET of the at least one CORESET associated with a lower identification and/or an earlier monitoring occasion if the at least one CORESET is associated with the repetition mode.

35. The method of claim 33, wherein
determining whether the at least one CORESET is associated with the at least one of the SFN mode or the repetition mode comprises:
determining that a CORESET of the at least one CORESET is associated with the repetition mode if the CORESET is configured with the repetition mode; and
monitoring the at least one CORESET based on the first and second TCI states comprises:
monitoring, based on the first TCI state, a first search space (SS) set of the CORESET associated with an earlier monitoring occasion of the CORESET; and
monitoring, based on the second TCI state, a second SS set of the CORESET associated with a later monitoring occasion of the CORESET.

36. The method of claim 32, wherein determining whether the at least one CORESET is associated with the at least one of the SFN mode or the repetition mode comprises:
determining that a CORESET of the at least one CORESET is associated with the SFN mode if the CORESET is configured with the SFN mode, and/or
determining that the CORESET is unassociated with the SFN mode if the CORESET is configured without the SFN mode.

37. The method of claim 32, wherein determining whether the at least one CORESET is associated with the at least one of the SFN mode or the repetition mode comprises:
receiving a first configuration of the SFN mode for a CORESET of the at least one CORESET;
receiving a second configuration of following an indication related to the first and second TCI states or an indication related to one of the first and second TCI states for the CORESET; and
determining that the CORESET is associated with the SFN mode if the indication related to the first and second TCI states is configured to be followed, or
determining that the CORESET is unassociated with the SFN mode if the indication related to the one of the first and second TCI states is configured to be followed.

38. The method of claim 32, wherein the at least CORESET is configured without an index of a resource pool, and/or with a single index of a resource pool.

39. The method of claim 32, wherein the indication related to the at least one TCI state is received via downlink control information (DCI).

40. A non-transitory computer readable medium comprising instructions stored thereon for causing an apparatus at least to perform:
receiving an indication related to at least one transmission configuration indicator (TCI) state of a plurality of TCI states including a first TCI state and a second TCI state;
determining whether at least one control resource set (CORESET) is associated with at least one of a single frequency network (SFN) mode or a repetition mode; and
monitoring the at least one CORESET based on the first TCI state if the at least one coreset is not associated with the at least one of the SFN mode or the repetition mode, or
monitoring the at least one CORESET based on at least the second TCI state if the at least one CORESET is associated with the at least one of the SFN mode or the repetition mode.

41. The non-transitory computer readable medium of claim 40, wherein, if the at least one CORESET is associated with the at least one of the SFN mode or the repetition mode, the apparatus is caused to monitor the at least one CORESET based on the first and second TCI states.

42. The non-transitory computer readable medium of claim 41, wherein monitoring the at least one CORESET based on the first and second TCI states comprises:
monitoring, based on the first TCI state, a CORESET of the at least one CORESET associated with a lower identification and/or an earlier monitoring occasion if the at least one CORESET is associated with the repetition mode.

43. The non-transitory computer readable medium of claim 40, wherein determining whether the at least one CORESET is associated with the at least one of the SFN mode or the repetition mode comprises:
determining that a CORESET of the at least one CORESET is associated with the repetition mode if the CORESET is configured with the repetition mode; and
monitoring the at least one CORESET based on the first and second TCI states comprises:
monitoring, based on the first TCI state, a first search space (SS) set of the CORESET associated with an earlier monitoring occasion of the CORESET; and
monitoring, based on the second TCI state, a second SS set of the CORESET associated with a later monitoring occasion of the CORESET.
